(19) United States
(12) Patent Application Publication
(10) Pub. No.: US 2013/0080668 A1
(43) Pub. Date: Mar. 28, 2013

(54) INTEGRATED CIRCUT WITH SERIAL INTERFACE, RECEIVING TRANSMITTAL INFORMATION CONFORMING TO TWO COMMUNICATION PROTOCOLS

(71) Applicant: Chun-Hsiung CHEN, Hsinchu City (TW)

(72) Inventor: Chun-Hsiung CHEN, Hsinchu City (TW)

(21) Appl. No.: 13/608,242

(22) Filed: Sep. 10, 2012

(30) Foreign Application Priority Data
Sep. 27, 2011 (TW) 100134745

(51) Int. Cl. G06F 13/42

(52) U.S. Cl. 710/106

(57) ABSTRACT

A processing system including a control integrated circuit (IC), a serial transmission interface, a transformation unit and an application unit is disclosed. The control IC provides transmittal information, which conforms to a first communication protocol or a second communication protocol. The serial transmission interface is coupled to the control IC and receives the transmittal information. The transformation unit is coupled to the serial transmission interface. The transformation unit transforms the transmittal information received by the serial transmission interface to generate processed information when the transmittal information conforms to the first communication protocol. The transformation unit transforms the transmittal information received by the serial transmission interface to generate the processed information when the transmittal information conforms to the second communication protocol. The application unit is coupled to the transformation unit and executes a corresponding operation according to the processed information.

### CROSS REFERENCE TO RELATED APPLICATIONS

This Application claims priority of Taiwan Patent Application No. 100134745, filed on Sep. 27, 2011, the entirety of which is incorporated by reference herein.

### BACKGROUND OF THE INVENTION

1. Field of the Invention

The invention relates to an integrated circuit (IC), and more particularly to an

IC, which comprises a serial interface, receiving first transmittal information conforming to a first communication protocol and second transmittal information conforming to a second communication protocol.

2. Description of the Related Art

With the development of technology, the sizes of integrated circuits (ICs) have been reduced and the circuit structures of ICs have become increasingly complex. Taking VLSI (very large scale integration) as an example, the number of elements has increased. Generally, each IC comprises at least one transmittal interface to communicate with other ICs.

However, a conventional IC only receives one kind of information conforming to a communication protocol. Thus, versatility of the IC is reduced because the conventional IC cannot receive another kind of information conforming to another communication protocol. Designers are required to design new ICs to receive different kinds of information conforming to different kinds of communication protocols. However, a new IC only receives one kind of information conforming to a communication protocol. The new IC cannot receive other kinds of information conforming to other communication protocols. Thus, the design cost of ICs is increased.

### BRIEF SUMMARY OF THE INVENTION

In accordance with an embodiment, a processing system comprises a control integrated circuit (IC), a serial transmission interface, a transformation unit and an application unit. The control IC provides transmittal information, which conforms to a first communication protocol or a second communication protocol. The serial transmission interface is coupled to the control IC and receives the transmittal information. The transformation unit is coupled to the serial transmission interface. The transformation unit transforms the transmittal information received by the serial transmission interface to generate processed information when the transmittal information conforms to the first communication protocol. The transformation unit transforms the transmittal information received by the serial transmission interface to generate the processed information when the transmittal information conforms to the second communication protocol. The application unit is coupled to the transformation unit and executes a corresponding operation according to the processed information.

In accordance with another embodiment, a processing integrated circuit (IC) comprises a serial transmission interface, a transformation unit and an application unit. The serial transmission interface receives first transmittal information or second transmittal information. The first transmittal information is provided by a first control IC and conforms to a first communication protocol. The second transmittal information is provided by a second control IC and conforms to a second communication protocol. The transformation unit is coupled to the serial transmission interface and transforms the first or the second transmittal information received by the serial transmission interface to generate processed information. The application unit is coupled to the transformation unit and provides a corresponding operation according to the processed information. The first communication protocol is different from the second communication protocol.

A processing method for processing transmittal information provided by a control integrated circuit (IC) is provided. The transmittal information conforms to a first communication protocol or a second communication protocol. An exemplary embodiment of a processing method is described in the following. The transmittal information is received. The transmittal information is transformed to generate processed information. When the transmittal information conforms to the first communication protocol, the transmittal information conforming to the first communication protocol is transformed. When the transmittal information conforms to the second communication protocol, the transmittal information conforming to the second communication protocol is transformed. A data access operation is executed according to the processed information.

A detailed description is given in the following embodiments with reference to the accompanying drawings.

### BRIEF DESCRIPTION OF THE DRAWINGS

The invention can be more fully understood by referring to the following detailed description and examples with references made to the accompanying drawings, wherein:

FIG. 1 is a schematic diagram of an exemplary embodiment of a processing system;

FIG. 2 is a schematic diagram of an exemplary embodiment of the first transmittal information;

FIG. 3 is a schematic diagram of an exemplary embodiment of the second transmittal information;

FIG. 4 is a schematic diagram of an exemplary embodiment of a transformation unit; and

FIG. 5 is a schematic diagram of an exemplary embodiment of a processing method.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

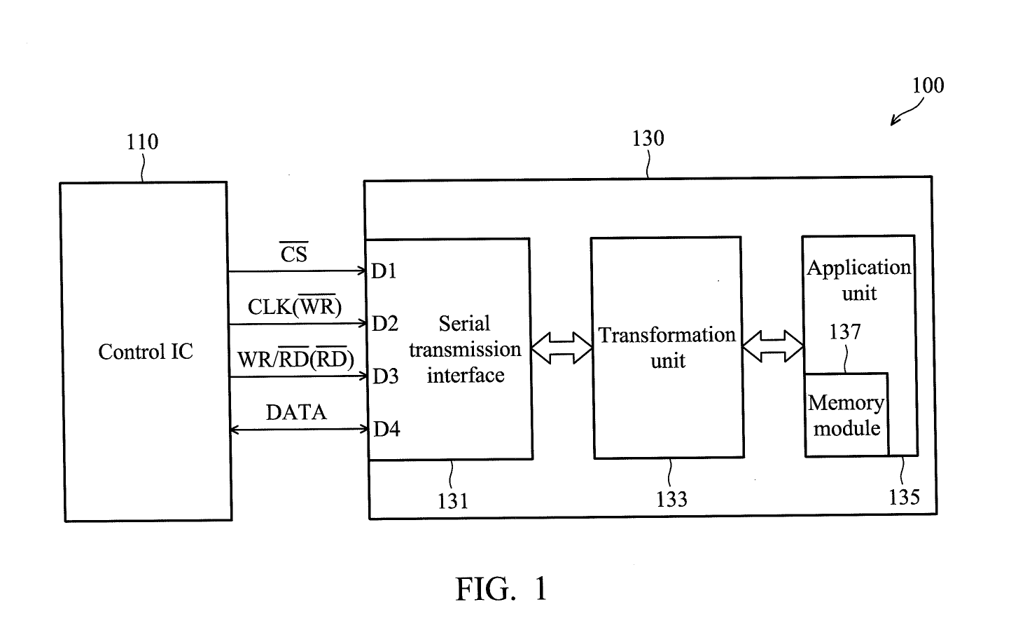

FIG. 1 is a schematic diagram of an exemplary embodiment of a processing system. The processing system 100 comprises a control IC 110 and a processing IC 130. Generally, different control ICs generate different transmittal information. The different transmittal information may conform to different communication protocols. For example, assuming the control IC 110 is a first IC. The first IC generates first transmittal information. The first transmittal information conforms to a first communication protocol. Assuming the control IC 110 is a second IC. The second IC generates second transmittal information. The second transmittal information conforms to a second communication protocol. The first communication protocol is different from the second communication protocol. 100161 In this embodiment, the processing IC 130 is capable of receiving and processing different transmittal information provided by different control ICs. For example, assume a first IC provides first transmittal information conforming to a first communication protocol and a second IC provides second transmittal information conforming to a second communication protocol. The processing IC 130 is capable of receiving and processing the first and the second transmittal information. Similarly, the processing IC 130 is capable of providing information to the control IC 110. The information provided by the processing IC 130 conforms to the first or the second communication protocol.

Compared to a conventional technology, the invention does not redesign a new IC to process additional transmittal information, which conforms to another communication protocol and is provided by another control IC. Thus, design cost is reduced. In addition, the processing IC of the invention can receive and process at least two communication protocols such that the elasticity of the processing IC is increased.

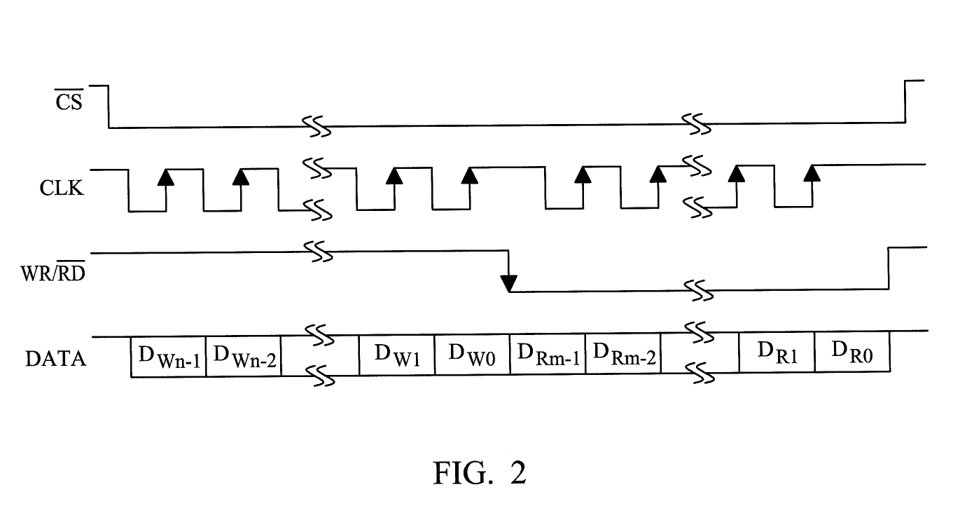

FIG. 2 is a schematic diagram of an exemplary embodiment of the first transmittal information. The first transmittal information comprises an activate signal C̅S̅, a clock signal CLK, a read-write signal WR/ R̅D̅, and a data signal DATA. In this embodiment, the data signal DATA is a serial data.

The activate signal C̅S̅ activates the processing IC 130 such that the processing

IC 130 communicates with the control IC 110. In FIG. 2, when the activate signal C̅S̅ is at a low level, the processing IC 130 processes the data signal DATA according to the clock signal CLK and the read-write signal WR/ R̅D̅.

For example, when the read-write signal WR/ R̅D̅ is at a high level, the processing IC 130 receives the data packets D_{Wn-1}˜D_{W0} provided by the control IC 110 according to the clock signal CLK. When the read-write signal WR/ R̅D̅ is at a low level, the processing IC 130 provides data packets D_{Rm-1}˜D_{R0} to the control IC 110 according to the clock signal CLK.

According to the above description, the control IC 110 accesses the data signal DATA according to two signals, such as the clock signal CLK and the read-write signal WR/ R̅D̅. Thus, in a first communication protocol, the clock signal CLK and the read-write signal WR/ R̅D̅ are simultaneously required for the processing IC 130.

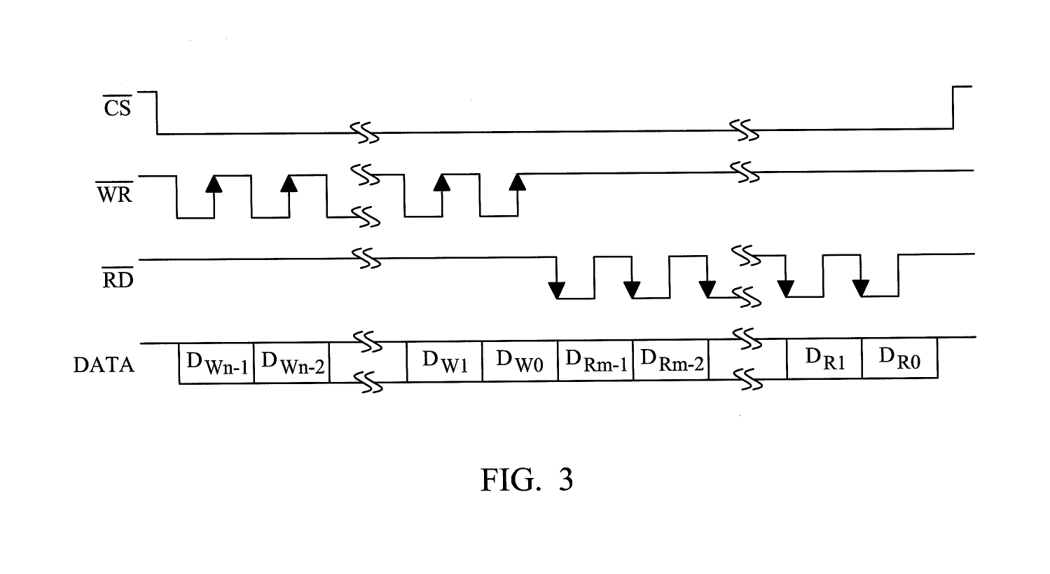

FIG. 3 is a schematic diagram of an exemplary embodiment of the second transmittal information. The second transmittal information comprises an activate signal C̅S̅, a write clock signal W̅R̅, a read clock signal R̅D̅ and a data signal DATA, but the disclosure is not limited thereto. In this embodiment, the data signal is also a serial data.

In other embodiments, the write clock signal W̅R̅ and the read clock signal R̅D̅ are not simultaneously required for the processing IC 130. For example, when the control IC 110 is assigned to write data into the processing IC 130, the control IC 110 sends a second transmittal information, which does not comprise a read clock signal R̅D̅. In this case, the second transmittal information only comprises an activate signal C̅S̅, a write clock signal W̅R̅, and a data signal DATA. In this embodiment, when the activate signal C̅S̅ is at a low level, the processing IC 130 reads data packets D_{Wn-1}˜D_{W0} provided by the control IC 110 according to the write clock signal W̅R̅.

Contrarily, when the control IC 110 is assigned to read data from the processing IC 130, the second transmittal information provided by the control IC does not comprise a write clock signal W̅R̅. The second transmittal information only comprises an activate signal C̅S̅, a read clock signal R̅D̅, and a data signal DATA. For example, when the activate signal C̅S̅ is at a low level, the processing IC 130 provides data packets D_{Rm-1}˜D_{R0} to the control IC 110 according to the read clock signal R̅D̅.

As the above describes, the control IC 110 utilizes one signal (e.g. a write clock signal W̅R̅ or a read clock signal R̅D̅) to send data signal DATA to the processing IC 130 or receive data signal DATA provided by the processing IC 130. Thus, in the second communication protocol, the write clock signal W̅R̅ and the read clock signal R̅D̅ are not simultaneously required for the processing IC 130.

Additionally, in this embodiment, the processing IC 130 can transform the transmittal information sent by the control IC 110 when the transmittal information sent by the control IC 110 conforms to the first or the second communication protocol. The processing IC 130 transforms the transmittal information sent by the control IC 110 from the first or the second communication protocol to a third communication protocol.

For example, assuming the control IC 110 is a first IC, which sends transmittal information conforming to a first communication protocol, in this case, the processing IC 130 can transform the transmittal information sent by the first IC to conform to a third communication protocol. Similarly, assuming the control IC 110 is a second IC, which sends transmittal information conforming to a second communication protocol. The processing IC 130 can transform the transmittal information sent by the second IC to conform to the third communication protocol. Thus, the processing IC 130 can process different transmittal information sent by different control ICs, wherein the different transmittal information conform to different communication protocols.

Referring to FIG. 1, the processing IC 130 comprises a serial transmission interface 131, a transformation unit 133 and an application unit 135. The serial transmission interface 131 is capable of receiving first transmittal information and second transmittal information. In this embodiment, the serial transmission interface 131 does not receive the first and the second transmittal information simultaneously.

For example, when the control IC 110 is a first IC sending first transmittal information conforming to a first communication protocol, the serial transmission interface 131 receives the first transmittal information. When the control IC 110 is a second IC sending second transmittal information conforming to a second communication protocol, the serial transmission interface 131 receives the second transmittal information.

The serial transmission interface 131 comprises transmittal terminals D1˜D4.

The transmittal terminal D1 receives an activate signal C̅S̅. The transmittal terminal D2 receives a clock signal CLK or a write clock signal W̅R̅. The transmittal terminal D3 receives a read-write signal WR/ R̅D̅ or a read clock signal R̅D̅. The transmittal terminal D4 receives a data signal DATA.

The transformation unit 133 transforms the transmittal information received by the serial transmission interface 131 to generate processed information. In this embodiment, the processed information conforms to a third communication protocol. The invention does not limit the kind of third communication protocol. In one embodiment, the third communication protocol is different from the first and the second communication protocols. In other embodiments, the third communication protocol is the same as one of the first and the second communication protocols.

The transmittal information provided by the control IC 110 conforms to a first communication protocol or a second communication protocol, and the transformation unit 133 is capable of transforming the transmittal information received by the serial unit 131 to an internet format, such as the third communication protocol. Thus, design cost is reduced. In addition, the transformation unit 133 provides the transformed result to the other units of the processing IC 130 such that the application and the elasticity of the processing IC 130 are increased.

The application unit 135 provides a corresponding operation according to the processed information generated by the transformation unit 133. The invention does not limit the kind of the corresponding operation. In this embodiment, the corresponding operation relates to the kind of the processing IC 130.

For example, if the processing IC 130 is a micro-controller unit (MCU), the application unit 135 executes a control operation according to the processed information generated by the transformation unit 133. Assume the processing IC 130 is a converter, such as an analog-to-digital converter (ADC) or a digital-to-analog converter (DAC). The application unit 135 executes a transformation operation. Assume the processing IC 130 is a display driver. The application unit 135 executes a display operation. Assume the processing IC 130 is a memory. The application unit 135 executes an access operation.

In this embodiment, the application unit 135 comprises a memory module 137 to store data. For example, if the control IC 110 executes a write operation for the processing IC 130, the transformation unit 133 generates processed information according to the received transmittal information and writes the processed information into the memory module 137.

On the contrary, if the control IC 110 executes a read operation for the processing IC 130, the transformation unit 133 generates processed information according to the received transmittal information, reads corresponding data from the memory module 137 according to the processed information and provides the read data to the control IC 110.

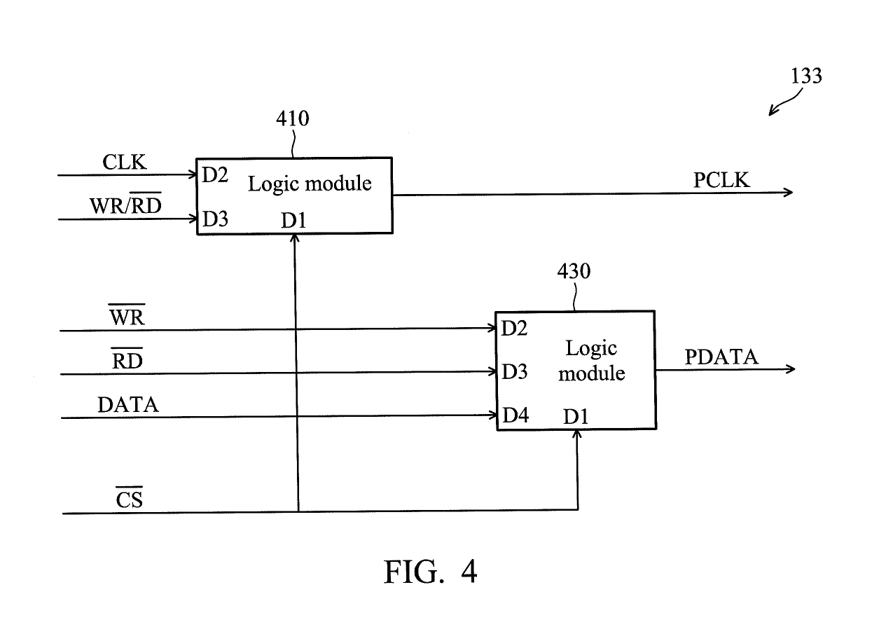

FIG. 4 is a schematic diagram of an exemplary embodiment of a transformation unit. The transformation unit 133 comprises logic modules 410 and 430. The logic module 410 integrates an activate signal C̅S̅, a clock signal CLK and a read-write signal WR/ R̅D̅ to generate a processing clock PCLK. The logic module 430 integrates the activate signal C̅S̅, the data signal DATA and at least one of the read clock signal R̅D̅ and the write clock signal W̅R̅ to generate a processing data PDATA. In one embodiment, the logic module 430 directly serves the data signal DATA as the processing data PDATA.

In this embodiment, the processing clock PCLK and the processing data PDATA are processed information and conform to a third communication protocol. Additionally, the invention does not limit the circuit structures of the logic modules 410 and 430. Any circuit can serve as the logic module, as long as the circuit is capable of integrating first transmittal information or second transmittal information.

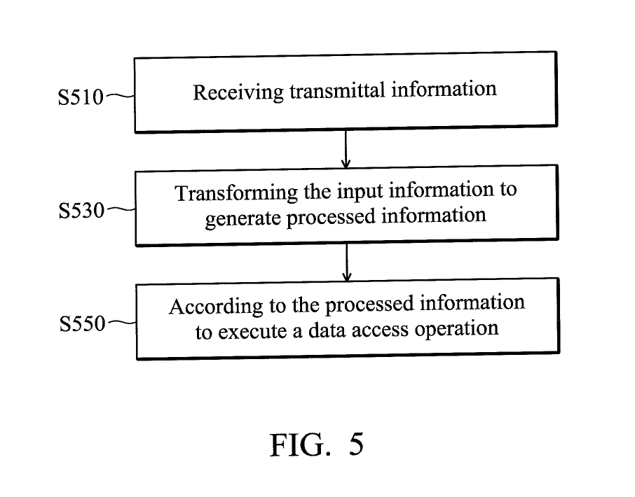

FIG. 5 is a schematic diagram of an exemplary embodiment of a processing method. The processing method processes transmittal information provided by a control integrated circuit (IC). The transmittal information is first transmittal information or second transmittal information. The first and the second transmittal information are shown in FIGS. 2 and 3. As shown in FIG. 2, the first transmittal information conforms to a first communication protocol. As shown in FIG. 3, the second transmittal information conforms to a second communication protocol. In this embodiment, the first communication protocol is different from the second communication protocol.

First, the transmittal information provided by a control IC is received (step S510). The invention does not limit the kind of the received transmittal information. In one embodiment, when the control IC provides first transmittal information conforming to a first communication protocol, the first transmittal information is received. When the control IC provides second transmittal information conforming to a second communication protocol, the second transmittal information is received. For brevity, the received transmittal information in step S510 is referred to as input information.

The input information is transformed to generate processed information (step S530). In this embodiment, the processed information conforms to a third communication protocol. The invention does not limit the kind of the third communication protocol. In one embodiment, the third communication protocol is different from the first and the second communication protocols. In other embodiments, the third communication protocol is the same as the first or the second communication protocol.

The invention does not limit the method of transforming the input information. In one embodiment, when the input information is the first transmittal information, which comprises clock information and read-write information, the method of transforming the input information is to integrate the clock information and the read-write information. When the input information is the second transmittal information, which comprises data information and one of read clock information and write clock information, the method of transforming the input information is to integrate the data information and one of the read clock information and the write clock information.

A data access operation is executed according to the processed information (step S550). For example, if the transmittal information provided from the control IC is read information, the data access operation is to provide data to the control IC. If the transmittal information provided from the control IC is write information, the data access operation is to store data provided from the control IC.

According to the above description, the processing IC of the invention can receive and process transmittal information provided from a control IC in anyway the transmittal information conforms to a first communication protocol or a second communication protocol. In other words, the same processing IC is capable of processing at least two communication protocols. Thus, elasticity of the processing IC is increased and a user does not have to consider whether a communication standard of the control IC matches a communication standard of the processing IC.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A processing system, comprising:
a control integrated circuit (IC) providing transmittal information, which conforms to a first communication protocol or a second communication protocol;
a serial transmission interface coupled to the control IC and receiving the transmittal information;
a transformation unit coupled to the serial transmission interface, wherein the transformation unit transforms the transmittal information received by the serial transmission interface to generate processed information when the transmittal information conforms to the first communication protocol, and the transformation unit transforms the transmittal information received by the serial transmission interface to generate the processed information when the transmittal information conforms to the second communication protocol; and
an application unit coupled to the transformation unit and executing a corresponding operation according to the processed information.

2. The processing system as claimed in claim 1, wherein when the transmittal information conforms to the first communication protocol, the transmittal information comprises a clock signal, an activate signal, a read-write signal and a data signal,
wherein when the transmittal information conforms to the second communication protocol, the transmittal information comprises an activate signal, a data signal and at least one of a read clock signal and a write clock signal, and
wherein the processed information conforms to a third communication protocol.

3. The processing system as claimed in claim 2, wherein the third communication protocol is the same as one of the first and the second communication protocols or is different from the first and the second communication protocols.

4. The processing system as claimed in claim 2, wherein the serial transmission interface comprises:
a first transmittal terminal receiving the activate signal;
a second transmittal terminal capable of receiving the clock signal and the write clock signal;
a third transmittal terminal capable of receiving the read-write signal and the read clock signal; and
a fourth transmittal terminal receiving the data signal.

5. The processing system as claimed in claim 2, wherein the transformation unit comprises:
a first logic module integrating the activate signal, the clock signal and the read-write signal to generate a processing clock; and
a second logic module integrating the activate signal, the data signal and at least one of the read clock signal and the write clock signal to generate a processing data.

6. The processing system as claimed in claim 1, wherein the processed information conforms to a third communication protocol.

7. A processing integrated circuit (IC), comprising:
a serial transmission interface receiving first transmittal information or second transmittal information, wherein the first transmittal information is provided by a first control IC and conforms to a first communication protocol, and the second transmittal information is provided by a second control IC and conforms to a second communication protocol;
a transformation unit coupled to the serial transmission interface and transforming the first or the second transmittal information received by the serial transmission interface to generate processed information; and
an application unit coupled to the transformation unit and providing a corresponding operation according to the processed information, wherein the first communication protocol is different from the second communication protocol.

8. The processing IC as claimed in claim 7, wherein the processed information conforms to the first or the second communication protocol.

9. A processing method processing transmittal information provided by a control integrated circuit (IC), wherein the transmittal information conforms to a first communication protocol or a second communication protocol, comprising:
receiving the transmittal information;
transforming the transmittal information to generate processed information, wherein when the transmittal information conforms to the first communication protocol, the transmittal information conforming to the first communication protocol is transformed, and when the transmittal information conforms to the second communication protocol, the transmittal information conforming to the second communication protocol is transformed; and
according to the processed information, executing a data access operation.

10. The processing method as claimed in claim 9, wherein when the transmittal information conforms to the first communication protocol, the transmittal information comprises a clock signal, an activate signal, a read-write signal and a data signal,
wherein when the transmittal information conforms to the second communication protocol, the transmittal information comprises an activate signal, a data signal and at least one of a read clock signal and a write clock signal, and
wherein the processed information conforms to a third communication protocol.

11. The processing method as claimed in claim 10, wherein the third communication protocol is the same as one of the first and the second communication protocols or is different from the first and the second communication protocols.

12. The processing method as claimed in claim 10, wherein the step of transforming the transmittal information to generate the processed information comprises:
when the transmittal information conforms to the first communication protocol, the activate signal, the clock signal and the read-write signal are integrated into a processing clock; and
when the transmittal information conforms to the second communication protocol, the activate signal, the data signal and at least one of the read clock signal and the write clock signal are integrated to a processing data.
